(19) United States
(12) Patent Application Publication
(10) Pub. No.: US 2018/0355958 A1
(43) Pub. Date: Dec. 13, 2018

(54) LINEAR ACTUATOR HAVING EXTERNAL VARIABLE LIMIT SWITCHES

(71) Applicant: VIP Cinema LLC, New Albany, MS (US)

(72) Inventor: Kenneth R. Graham, Tupelo, MS (US)

(73) Assignee: VIP Cinema LLC, New Albany, MS (US)

(21) Appl. No.: 16/001,898

(22) Filed: Jun. 6, 2018

Related U.S. Application Data
(60) Provisional application No. 62/516,570, filed on Jun. 7, 2017.

(51) Int. Cl. F16H 25/20; H02K 7/06; F16H 25/24

(52) U.S. Cl. CPC F16H 25/2015; A47C 1/02; F16H 25/2454; H02K 7/06

(57) ABSTRACT

The present invention is directed to a linear actuator including an external adjustable variable limit switch. The linear actuator allows the position of the limit switch to be adjusted without disassembling the linear actuator or motor. In one embodiment, the linear actuator includes a profile tube having an upper end and a lower end, a slot that runs from the upper end to the lower end of the profile tube, and an internal track that runs from the upper end to the lower end of the profile tube. The linear actuator also includes at least one limit switch mounted on the slot and a limit switch adjuster and a locking fastener configured to permit the position of the limit switch to be adjusted without disassembly of the linear actuator or motor. The limit switch adjuster is further configured to be positioned in the internal track.

### CROSS-REFERENCE TO RELATED APPLICATIONS

This application claims the benefit of U.S. Provisional Application 62/516,570, filed Jun. 7, 2017, the entirety of which is herein incorporated by reference.

### BACKGROUND OF THE INVENTION

### Field of the Invention

The disclosure relates to a linear actuator with one or more externally adjustable variable limit switches. In particular, the disclosure relates to a linear actuator including one or more externally adjustable variable limit switches and a profile tube configured to accommodate such limit switches.

### Background

A linear actuator is a type of actuator that creates motion in a straight line (linear movement) along a desired path, typically reciprocating linear movement. A linear actuator is used in a variety of devices including but not limited to machine tools, industrial machinery, computer peripherals such as disk drives and printers, in valves and dampers and many other devices where linear motion is required. A linear actuator is also used, for example, in theater furniture to change the position of the various components of a theater chair. Users may activate the linear actuator by means of electrical contacts (e.g., buttons) that are mounted within close proximity to the user.

Linear actuators are well-known in the art. A typical linear actuator, as shown in FIG. 1, includes an electric motor 3 with a rotatable output shaft 4 (e.g., motor worm gear). The output shaft 4 is connected through a gear train 5 (e.g., COGG wheel gear) to a spindle nut 7 and a lead screw mechanism 6 (e.g., spindle). Rotation of the output shaft 4 of the electric motor 3 causes the corresponding rotation of the lead screw mechanism 6. Nut 7 has an opening formed therethrough having an internal thread (not shown). Lead screw mechanism 6 extends through the opening of nut 7 and has an external thread formed that engages with the internal thread of nut 7. Nut 7 is mounted on lead screw 6 in a way that prevents its rotation when said lead screw 6 rotates. As a result, rotation of lead screw 6 causes axial/linear movement of the nut 7 axially along the lead screw 6. The direction of the axial/linear movement of nut 7 (and the work piece connected thereto) is dependent upon the direction of rotation of lead screw 6. The linear actuator includes a lower housing 1 and an upper housing 2 for enclosing the electric motor 3. The linear actuator also includes a profile tube 12 configured for receiving lead screw 6. FIG. 2 is an enlarged view of the linear actuator depicted in FIG. 1 that shows the wheel gear 5, the spindle nut 7, and a switch paddle 8.

The primary function of the limit switch is to control the polarity of the motor direction, in which will drive the spindle nut 7 forward or backwards. When the external actuator button is pressed, an electrical current is sent through limit switches 9 & 10 by the means of an electrical wiring to the motor 3 energizing the motor, rotating the output shaft 4 vertical axis. The output shaft 4 will turn against the wheel gear 5 (e.g., COGG wheel gear) causing a rotation of the horizontal axis of the spindle 6 in which the spindle 6 has a threaded pitch (or screw). This threaded pitch will drive the spindle nut 7 horizontally down the spindle 6. With the spindle nut 7 at its starting position there is a switch paddle 8 attached to the spindle nut 7 that is resting on limit switch 9. With the switch paddle 8 at a starting point against the limit switch 9, it will control the motor rotation direction to allow the motor 3 to rotate only in one direction, either clockwise or counter clockwise. As the spindle nut 7 is driving toward the second limit switch 10, the switch paddle 8 will make contact with the limit switch 10, which will turn off the motor 3 and only allow the motor 3 to drive in reverse. This same action works the same way when the actuator button is pressed for the opposite direction. The wiring 11 for the limit switches 9, 10 come in thru the actuator switch thru the cable to the limit switches 9, 10. Electrical wiring connections from the limit switches 9, 10 to the motor 3 control direction of rotation for the motor 3.

Typically on prior art linear actuators, the limit switches have predetermined and fixed start and stop positions. For example, if a user opts for a 5 inches position, the switches are physically mounted on a circuit board strip and the distance of 5 inches is always fixed. Such fixed and predetermined positions of limit switches do not provide the required flexibility for certain applications. Readjusting a predetermined limit switch position is a costly hassle when, for example, furnishing a theater hall with different sections, some sections of which require chairs with differing reclining capabilities. Front row chairs should be able to recline more than chairs in other sections of the theater hall. The position of the limit switches for actuators of front row chairs are, therefore, different. To install front section chairs, installers currently have to either 1—custom order various motors with different limit switch settings or 2—order one type of motor with a preset, predetermined limit switch position (a more cost-effective option) and disassemble the motor to reset the position of the limit switches as needed. It is desirable, therefore, to have a motor on which the positions of the limit switches can be reset without necessitating disassembly. The ability to procure one type of motor for all chairs of a theater hall, and set external limit switches to provide variable positions when needed, without having to take apart the motor saves time and labor costs. There is a need, therefore, for linear actuators that can provide variable set distances for limit switches. There is also a need to be able to externally adjust the limit switches without having to take the motor apart.

### SUMMARY OF INVENTION

The present invention now provides a linear actuator that includes a profile tube having an upper end and a lower end; a slot that runs from the upper end to the lower end of the profile tube; an internal track that runs from the upper end to the lower end of the profile tube; at least one limit switch configured to be mounted in the slot; and a limit switch adjuster and a locking fastener configured to allow the position of the limit switch to be adjusted without disassembly of the linear actuator. The limit switch adjuster is further configured to be positioned in the internal track.

The present invention thus provides an improved linear actuator with limit switches that are easily adjustable without disassembly, including an improved linear actuator that allows for the external adjustment of its limit switches without the need for disassembly.

The present invention also provides a chair having the above linear actuator for adjusting the position of the chair upon demand by the user.

In one embodiment, the slot can house the limit switch and the position of the limit switch in the slot can be adjusted externally.

In one embodiment, the linear actuator may further comprise a spindle, a wheel gear, and a spindle nut. The wheel gear may be configured to be mounted on one end of the spindle. The spindle may be configured to be inserted into the slot. The spindle may be further configured to be inserted into the slot via the spindle nut. The spindle may be a screw.

In one embodiment, the linear actuator may further comprise an assembly of a lower housing, an upper housing, a motor, and an output shaft. The assembly may include an opening configured to engage with the wheel gear.

In one embodiment, the locking fastener may be configured to engage with the limit switch adjuster. The locking fastener may be configured to lock the limit switch in the slot so that the limit switch is immovable in the slot. Locking the limit switch in the slot may be achieved without disassembling the linear actuator. The locking fastener may be configured to loosen the limit switch in the slot so that the limit switch is movable in the slot. Loosening the limit switch in the slot may be achieved without disassembling the linear actuator.

A recliner chair comprising the above linear actuator is also contemplated.

Methods for using the above improved linear actuator and profile tube are also contemplated.

### BRIEF DESCRIPTION OF THE DRAWINGS

It is understood that the figures presented herein should not be deemed to limit or define the subject matter claimed herein. Applicant's invention may be understood by reference to the following description taken in conjunction with the accompanying drawings, in which:

FIG. 1 depicts an exploded view of a prior art linear actuator illustrating its various components.

FIG. 2 illustrates a wheel gear, a spindle nut and a switch paddle of the linear actuator shown in FIG. 1.

FIG. 3 depicts an exploded view of a linear actuator with external variable limit switches in accordance with the current invention.

FIG. 4 illustrates an exploded view of a profile tube and other components of the linear actuator in accordance with the current invention.

FIG. 5 shows a cross-sectional view of a profile tube including a slot, an internal track, a limit switch, and a limit switch adjuster in accordance with the current invention.

### DESCRIPTION OF ILLUSTRATIVE EMBODIMENTS

Illustrative embodiments of the invention are described below. In the interest of clarity, not all features of an actual implementation are described in this specification. The following detailed description of exemplary embodiments, read in conjunction with the accompanying drawings, is merely illustrative and is not to be taken as limiting the scope of the invention. Rather, the scope of the invention is defined by the appended claims and equivalents thereof. It will of course be appreciated that in the development of an actual embodiment, numerous implementation-specific decisions must be made to achieve the design-specific goals, which will vary from one implementation to another. Moreover, it will be appreciated that such a development effort, while possibly complex and time-consuming, would nevertheless be a routine undertaking for persons of ordinary skill in the art having the benefit of this disclosure. Further aspects and advantages of the various embodiments of the invention will become apparent from consideration of the following description and drawings. It is noted, however, that the figures are not necessarily drawn to scale.

In accordance with the current invention, herein is provided an improved linear actuator that allows for the external adjustment of its limit switches without the need for disassembly. Prior art standard linear actuator with a conventional profile tube has fixed limit switches set at predetermined start and stop positions. The current invention provides limit switches that can be adjusted externally and a profile tube incorporated therein has a slot and an internal track that run down the tube. The profile tube is configured to accommodate the limit switches and allow the limit switches to travel in the slot for infinitely adjustable positions. Locking the limit switches into the desired position is accomplished by using a limit switch adjuster and a locking fastener (e.g., a screw). The locking fastener can be externally inserted into the limit switch adjuster in the internal track. Such a locking system (limit switch adjuster and locking fastener) allows the limit switches to move along the slot to a new position.

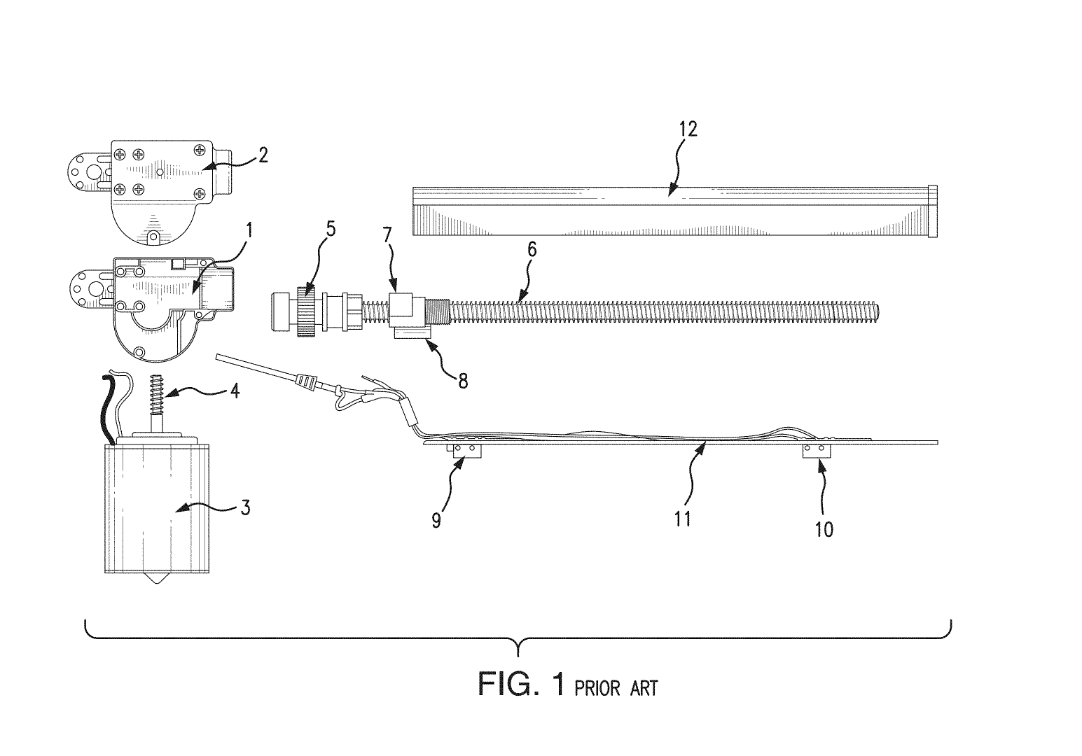

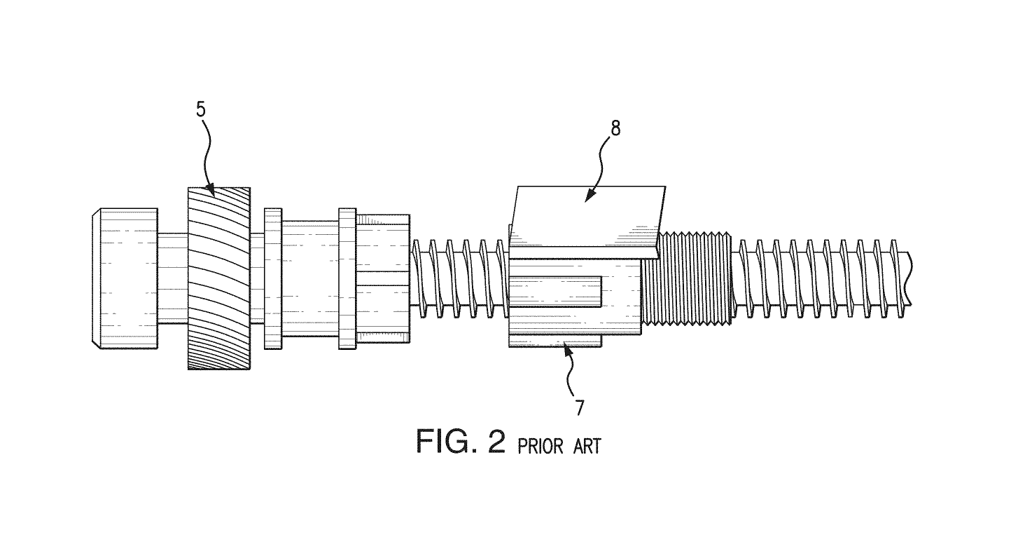

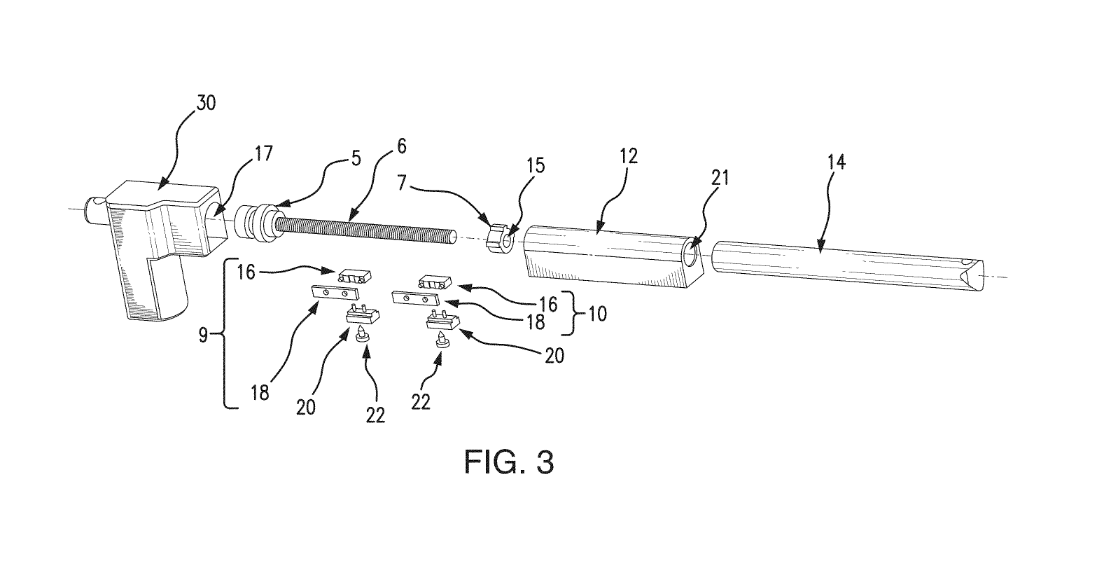

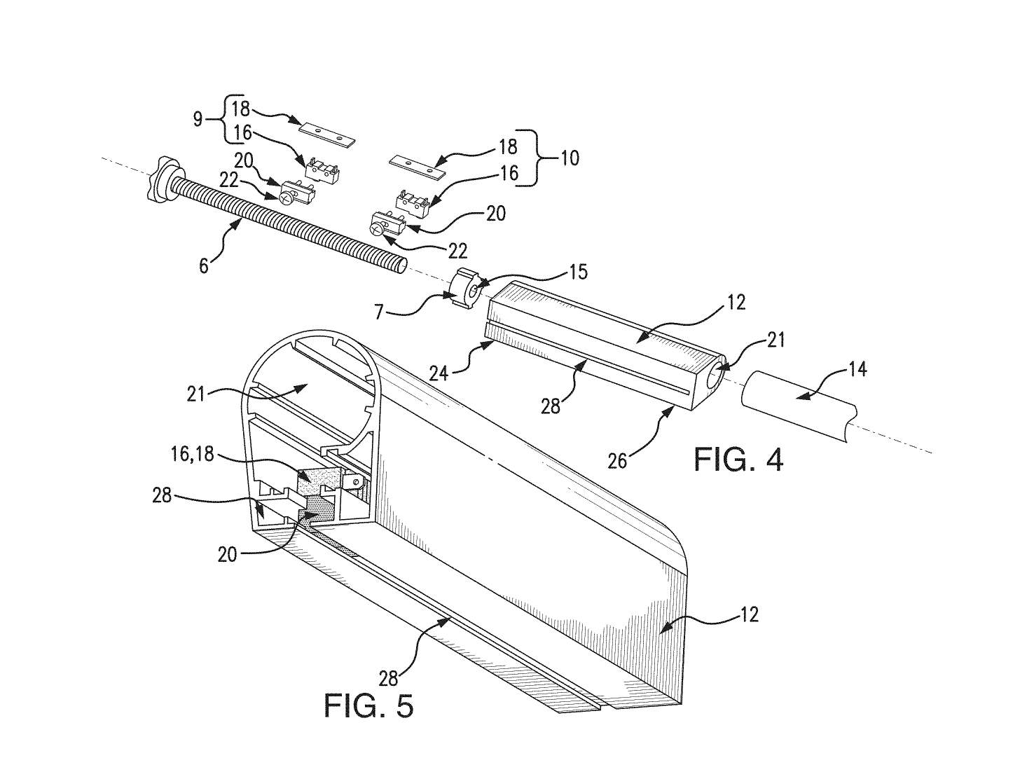

Referring now to the drawings, FIGS. 3 and 4 depict a linear actuator in accordance with the current invention. The illustrated linear actuator includes the assembly 30 of a lower housing, an upper housing, a motor, and an output shaft, a wheel gear 5 (e.g., COGG wheel gear), a spindle 6, a spindle nut 7, limit switches 9 and 10, a limit switch adjuster 20, a locking fastener 22, and a profile tube 12. The linear actuator may also include a switch paddle (not shown). The gear 5 is configured to be mounted on one end of the spindle 6. The gear 5 is also configured to be inserted into or engaged with an opening 17 of the assembly 30. The spindle 6 is configured to be inserted into a slot 21 of the profile tube 12 via the spindle nut 7. The spindle nut 7 has an opening 15. The spindle 6 may be a screw, bolt, or other threaded member configured to engage with the slot 21 of the profile tube 12. The motor can be of any type depending on the type of application in which the linear actuator is to be used. The lower housing, upper housing, motor, output shaft, wheel gear 5, spindle 6, spindle nut 7, and switch paddle may be conventional components that are well known in the art, such as those disclosed in prior art FIGS. 1 and 2. Each of the adjustable limit switches 9 and 10 includes a base 16 and a mounting plate 18. The limit switch 9, 10 is secured to the profile tube 12 by the limit switch adjuster 20 and the locking fastener 22. The linear actuator further includes a stroke tube 14. The stroke tube 14 is a telescopic tube configured to drive in and out (or move back and forth in a longitudinal direction) of the profile tube 12. The movement of the stroke tube 14 may be controlled by the motor.

Referring to FIGS. 4 and 5, the linear actuator of the current invention includes an improved profile tube 12 having a slot 21 that runs from its upper end 24 to its lower end 26 and an internal track 28 beneath the slot 21 that also runs from the upper end 24 of the profile tube 12 to the lower end 26 of the profile tube 12. The internal track 28 is configured to guide the limit switch adjuster 20. The profile tube 12, the slot 21, and the internal track 28 may have the same length or different lengths. The profile tube 12, the slot 21, and the internal track 28 extend in the same direction (e.g., in a longitudinal direction). With the help of the limit switch adjuster 20, the position of limit switches 9 and 10 can be determined by means of locking fasteners 22 (e.g., screws) without having to disassemble the linear actuator. For example, each of limit switches 9 and 10 can be loosened from the slot 21 by unfastening the respective locking fastener 22, moved to a different location in the slot 21 (by moving the limit switch adjuster 20 to a different location in the track 28) while the limit switch 9/10 is loosened, and then fixed in another location in the slot 21 by fastening the respective locking fastener 22. When the limit switch 9/10 is loosened, the limit switch 9/10 is movable in the slot 21 by moving the limit switch adjuster 20 connected to the limit switch 9/10. When the limit switch 9/10 is fixed, the limit switch 9/10 is immovable in the slot 21 via the limit switch adjuster 20. As such, the position of the limit switch 9/10 in the slot 21 can be adjusted without taking apart the assembly 30 or the linear actuator.

The limit switch 9/10 and the limit switch adjuster 20 can be slid in from one end of the profile tube 12 (e.g., the same end of the profile tube 12 that receives the spindle 6) into the profile tube 12, slot 21, and/or internal track 28. When the limit switch 9/10 and limit switch adjuster 20 are installed in the profile tube 12, the limit switch 9/10 is in the slot 21 and the limit switch adjuster 20 is in the internal track 28. The locking fastener 22 is inserted from the outside of the internal track 28 into the limit switch adjuster 20 in the internal track 28. The limit switch adjuster 20 includes one or more pins to engage with the limit switch 9/10. The limit switch 9/10 (e.g., the base 16) includes one or more corresponding holes to receive the one or more pins. The locking fastener 22 is inserted into the limit switch adjuster 20 to hold the limit switch adjuster 20 in place, and the limit switch adjuster 20 in turn holds the limit switch 9/10 in place via the one or more pins inserted into the corresponding holes. The locking fastener 22 and the limit switch adjuster 20 may be configured in a manner such that the locking fastener 22 extends only partially into the limit switch adjuster 20 (e.g., about ¾ through the height of the limit switch adjuster 20) when they are secured together. As such, the locking fastener 22 need not extend beyond the limit switch adjuster 20 and need not contact the limit switch 9/10. When the limit switch 9/10 is unfastened, the limit switch 9/10 stays (and is movable) in the slot 21 and the limit switch adjuster 20 stays (and is movable) in the internal track 28. The internal track 28 may have a shape that corresponds to the shape of the limit switch adjuster 20.

There are at least three ways to deal with excess wiring that is needed to allow the external adjustment of limit switches in a profile tube. The first way is to include an access box with the chair to store excess wire. The second way is to include a self-storing connection wire similar to a telephone handset cord. The third way is to use an electrical track system that runs the length of the profile tube.

The linear actuator described by this application provides several improvements over the existing linear actuators. One improvement, for example, is directed to the structures of the profile tube. Another improvement, for example, is directed to the structures of the limit switch and the limit switch adjuster and the usage of a locking fastener. These features allow the position of the limit switches to be adjusted without disassembling the linear actuator. The position of the limit switches can be adjusted externally. Therefore, the reclining capability of a seat (e.g., theatre seat) can be adjusted without hassle. A professional installing a theatre seat can adjust the front theatre seats to have a wider reclining angle and the back theatre seats to have a smaller reclining angle without taking the linear actuator or other components apart. The features contemplated by the present invention also eliminate the need to order separate linear actuators with different predetermined limit switch settings/positions for the front seats, back seats, and seats in other locations. As such, the cost for installing or adjusting such a chair can be reduced. Each seat in the theatre or other location can be equipped with the same linear actuator or limit switches, and the position of the limit switches can be adjusted accordingly.

It will be understood by one of ordinary skill in the art that in general any subset or all of the various embodiments and inventive features described herein may be combined, notwithstanding the fact that the claims set forth only a limited number of such combinations.

What is claimed is:

1. A linear actuator comprises:
a profile tube having an upper end and a lower end;
a slot that runs from the upper end to the lower end of the profile tube;
an internal track that runs from the upper end to the lower end of the profile tube;
at least one limit switch configured to be mounted in the slot; and
a limit switch adjuster and a locking fastener configured to allow the position of the limit switch to be adjusted without disassembly of the linear actuator, wherein the limit switch adjuster is further configured to be positioned in the internal track.

2. The linear actuator of claim 1, wherein the linear actuator further comprises a spindle, a wheel gear, and a spindle nut.

3. The linear actuator of claim 2, wherein the wheel gear is configured to be mounted on one end of the spindle.

4. The linear actuator of claim 2, wherein the spindle is configured to be inserted into the slot.

5. The linear actuator of claim 2, wherein the spindle is configured to be inserted into the slot via the spindle nut.

6. The linear actuator of claim 2, wherein the linear actuator further comprises an assembly of a lower housing, an upper housing, a motor, and an output shaft.

7. The linear actuator of claim 6, wherein the assembly includes an opening configured to engage with the wheel gear.

8. The linear actuator of claim 2, wherein the spindle is a screw.

9. The linear actuator of claim 1, wherein the locking fastener is configured to engage with the limit switch adjuster.

10. The linear actuator of claim 1, wherein the locking fastener is configured to lock the limit switch in the slot so that the limit switch is immovable in the slot.

11. The linear actuator of claim 10, wherein the locking fastener is configured to lock the limit switch in the slot without disassembling the linear actuator.

12. The linear actuator of claim 1, wherein the locking fastener is configured to loosen the limit switch in the slot so that the limit switch is movable in the slot.

13. The linear actuator of claim 12, wherein the locking fastener is configured to loosen the limit switch in the slot without disassembling the linear actuator.

14. The linear actuator of claim 1, wherein the limit switch comprises a base and a mounting plate.

15. A recliner chair comprises:
a linear actuator configured to adjust position of the recliner chair, wherein the linear actuator includes:
a profile tube having an upper end and a lower end;
a slot that runs from the upper end to the lower end of the profile tube;
an internal track that runs from the upper end to the lower end of the profile tube;
at least one limit switch configured to be mounted in the slot; and
a limit switch adjuster and a locking fastener configured to allow the position of the limit switch to be adjusted without disassembly of the linear actuator, wherein the limit switch adjuster is further configured to be positioned in the internal track.
